(19) United States
(12) Patent Application Publication
(10) Pub. No.: US 2026/0295813 A1
(43) Pub. Date: Oct. 1, 2026

(54) ROBOT

(71) Applicants: DMG MORI CO., LTD., NARA (JP); PUBLIC UNIVERSITY CORPORATION NARA MEDICAL UNIVERSITY, NARA (JP)

(72) Inventors: Hideki NAGASUE, NARA (JP); Yuta NABETA, NARA (JP); Shukichi AKAI, NARA (JP); Yasuaki NAKANISHI, NARA (JP); Hideo HASEGAWA, NARA (JP)

(73) Assignees: DMG MORI CO., LTD., NARA (JP); PUBLIC UNIVERSITY CORPORATION NARA MEDICAL UNIVERSITY, NARA (JP)

(21) Appl. No.: 19/177,096

(22) Filed: Apr. 11, 2025

(30) Foreign Application Priority Data
Mar. 26, 2025 (JP) 2025-051815

(51) Int. Cl. B25J 9/10; F16H 25/18; F16H 25/20

(52) U.S. Cl. CPC B25J 9/102; F16H 25/2018; F16H 2025/2075

(57) ABSTRACT

A robot for scanning using an ultrasonic probe includes a holding portion configured to hold the ultrasonic probe, a first slide mechanism connected to the holding portion and configured to slide the holding portion in an axial direction of a first axis intersecting with the ultrasonic probe, and a first rotation mechanism connected to the holding portion and configured to rotate the holding portion around the first axis.

### CROSS REFERENCE TO RELATED APPLICATIONS

This nonprovisional application is based on Japanese Patent Application No. 2025-051815 filed on Mar. 26, 2025 with the Japan Patent Office, the entire contents of which are hereby incorporated by reference.

### BACKGROUND OF THE INVENTION

### Field of the Invention

The present invention relates to a robot.

### Description of the Background Art

For example, Japanese Patent Laying-Open No. 2010-82333 discloses an ultrasonic inspection robot system including an ultrasonic probe and a robot arm that holds the ultrasonic probe.

Japanese Patent No. 6,559,956 discloses a robot system including an ultrasonic probe and a robot to which the ultrasonic probe is connected.

Japanese Patent No. 7,387,502 discloses an ultrasonic automatic scan system including an ultrasonic probe and a mechanical structure that holds the ultrasonic probe. The mechanical structure can move the ultrasonic probe in horizontal and vertical directions and change an angle of the ultrasonic probe.

### SUMMARY OF THE INVENTION

As disclosed in Japanese Patent Laying-Open No. 2010-82333, Japanese Patent No. 6,559,956 and Japanese Patent No. 7,387,502 above, a robot for scanning an ultrasonic probe on an affected area is used for the purpose of decreasing the difficulty of surgery and of reducing the workload of a doctor. Such a robot is required to change a range of image pick-up by the ultrasonic probe as intended and to easily sharpen an obtained image in order to smoothly perform the image pick-up work using the ultrasonic probe.

An object of the present invention is to provide a robot capable of smoothly performing the image pick-up work using an ultrasonic probe.

A robot according to the present invention is a robot for scanning an ultrasonic probe. The robot includes: a holding portion that can hold the ultrasonic probe; a first slide mechanism that is connected to the holding portion and slides the holding portion in an axial direction of a first axis intersecting with the ultrasonic probe; and a first rotation mechanism that is connected to the holding portion and rotates the holding portion around the first axis.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a robot according to an embodiment of the present invention.

FIG. 2 is a cross-sectional view showing the robot in FIG. 1.

FIG. 3 is a cross-sectional view showing the robot in an area surrounded by chain double-dashed line III in FIG. 2.

FIG. 4 is a cross-sectional view schematically showing the workings of a first rotation mechanism and a first slide mechanism.

FIG. 5 is a cross-sectional view showing the robot in an area surrounded by chain double-dashed line V in FIG. 2.

FIG. 6 is a cross-sectional view showing the robot in an area surrounded by chain double-dashed line VI in FIG. 2.

FIG. 7 is a perspective view showing an internal structure of the robot in FIG. 6.

FIG. 8 is a cross-sectional view showing the robot in an area surrounded by chain double-dashed line VIII in FIG. 2.

FIG. 9 is an exploded view of the robot in FIG. 1.

### DESCRIPTION OF THE PREFERRED EMBODIMENTS

An embodiment of the present invention will be described with reference to the drawings. In the drawings referenced below, the same or corresponding members are denoted by the same reference numerals.

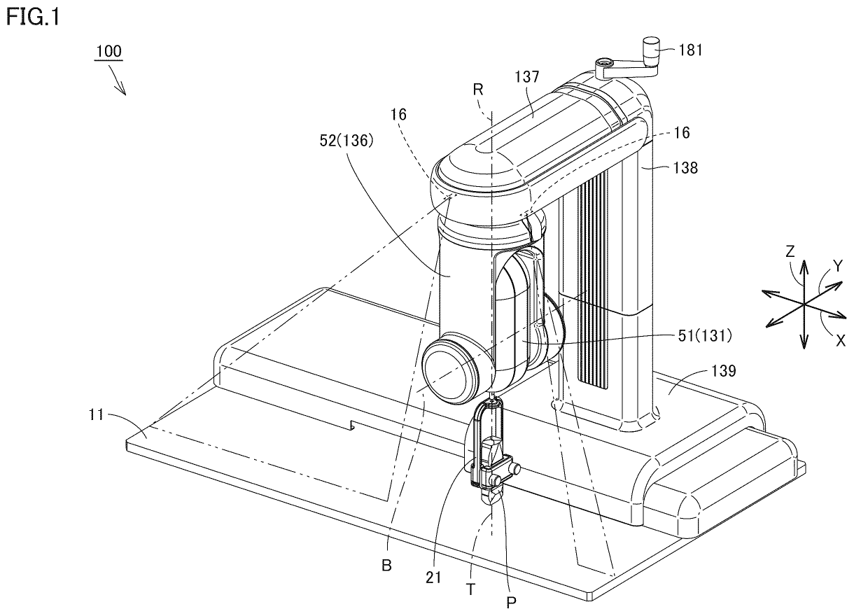

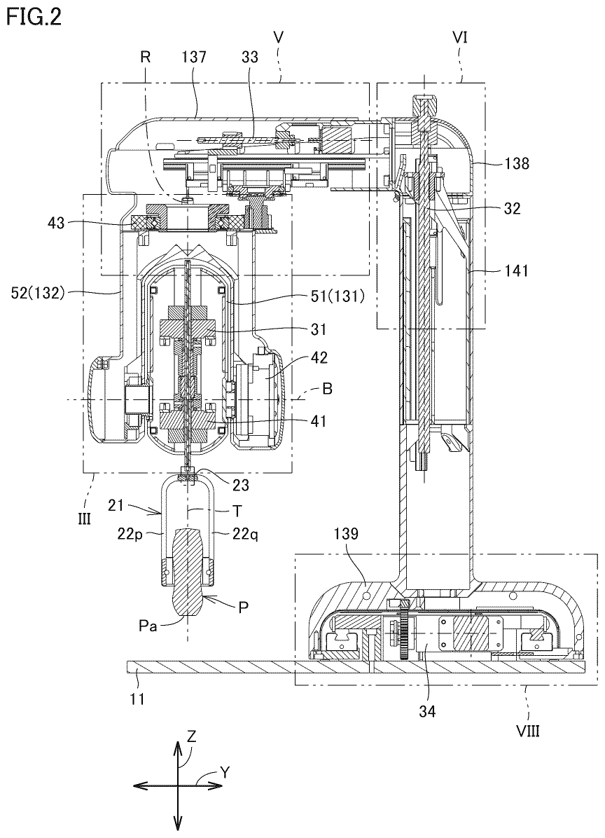

FIG. 1 is a perspective view showing a robot according to an embodiment of the present invention. FIG. 2 is a cross-sectional view showing the robot in FIG. 1.

FIGS. 1 and 2 and FIGS. 3 to 5 described below show a T axis, a B axis orthogonal to the T axis, and an R axis orthogonal to the B axis. The T axis corresponds to “first axis” in the present invention, the B axis corresponds to “second axis” in the present invention, and the R axis corresponds to “third axis” in the present invention.

Furthermore, FIGS. 1 and 2 and FIGS. 5 to 9 described below show a Z axis extending in an up-down direction, a Y axis being orthogonal to the Z axis and extending in a horizontal direction, and an X axis being orthogonal to each of the X axis and the Y axis and extending in the horizontal direction. An axial direction of the Z axis (hereinafter also referred to as “Z-axis direction”) corresponds to “first direction” in the present invention, an axial direction of the Y axis (hereinafter also referred to as “Y-axis direction”) corresponds to “second direction” in the present invention, and an axial direction of the X axis (hereinafter also referred to as “X-axis direction”) corresponds to “third direction” in the present invention.

Referring to FIGS. 1 and 2, a robot 100 according to the present embodiment is a robot for scanning an ultrasonic probe P on an affected area.

As an example, robot 100 is used for treatment of stenosing flexor tenosynovitis (trigger finger). In this case, the palm, which is an affected area, is placed on a below-described pedestal 11 in such a posture that an arm is oriented in the X-axis direction. A doctor is positioned to face the affected area in the Y-axis direction. By operating robot 100 using an operation terminal such as a touch panel or a foot pedal, the doctor scans ultrasonic probe P on the affected area. With scanning of ultrasonic probe P, shape data of the affected area is obtained and imaged. The doctor operates robot 100 and provides treatment for the affected area using a treatment device while checking an image shown on a display.

In the present invention, a portion of the affected area on which the ultrasonic probe is scanned is not particularly limited and may be, for example, an arm or a leg. The ultrasonic probe is used not only for treatment of the affected area but also for searching for an anesthesia injection point, for example.

Robot 100 has pedestal 11. Pedestal 11 is made of a flat plate whose thickness direction corresponds to the Z-axis direction. Pedestal 11 functions as a placing table on which the affected area is placed and functions as a support stand that supports a below-described structure of robot 100.

Robot 100 further has a holding portion 21. Holding portion 21 can hold ultrasonic probe P. Ultrasonic probe P is detachably held by holding portion 21, using a fastening tool such as a screw, a clip or a plate. Holding portion 21 holds ultrasonic probe P such that ultrasonic probe P is disposed at a position away from pedestal 11 in the Z-axis direction.

Ultrasonic probe P has a tip portion Pa. Tip portion Pa is provided at a tip of ultrasonic probe P. Tip portion Pa is a portion of ultrasonic probe P that is pressed against the affected area and receives and transmits ultrasonic waves. When ultrasonic probe P is viewed in an axial direction of the T axis described below (hereinafter also referred to as “T-axis direction”), tip portion Pa has a substantially rectangular shape. Holding portion 21 holds ultrasonic probe P such that ultrasonic probe P is disposed at a position where tip portion Pa protrudes from holding portion 21 in the T-axis direction.

Holding portion 21 has a pair of arm portions 22p and 22q and a base portion 23. Base portion 23 extends in the horizontal direction. The pair of arm portions 22p and 22q extend in the Z-axis direction from both ends of base portion 23, respectively. Together with base portion 23, the pair of arm portions 22p and 22q form the U shape. The pair of arm portions 22p and 22q are spaced apart from each other and face each other in the horizontal direction. Ultrasonic probe P is held between the pair of arm portions 22p and 22q and at a position where holding portion 21 faces base portion 23 in the T-axis direction.

The T axis is an imaginary straight line and corresponds to a rotation central axis of ultrasonic probe P held by holding portion 21. The T axis intersects with ultrasonic probe P held by holding portion 21. Ultrasonic probe P extends in a rod shape along the T axis. The T axis intersects with tip portion Pa of ultrasonic probe P held by holding portion 21. The T axis intersects with holding portion 21. The T axis intersects with base portion 23 of holding portion 21.

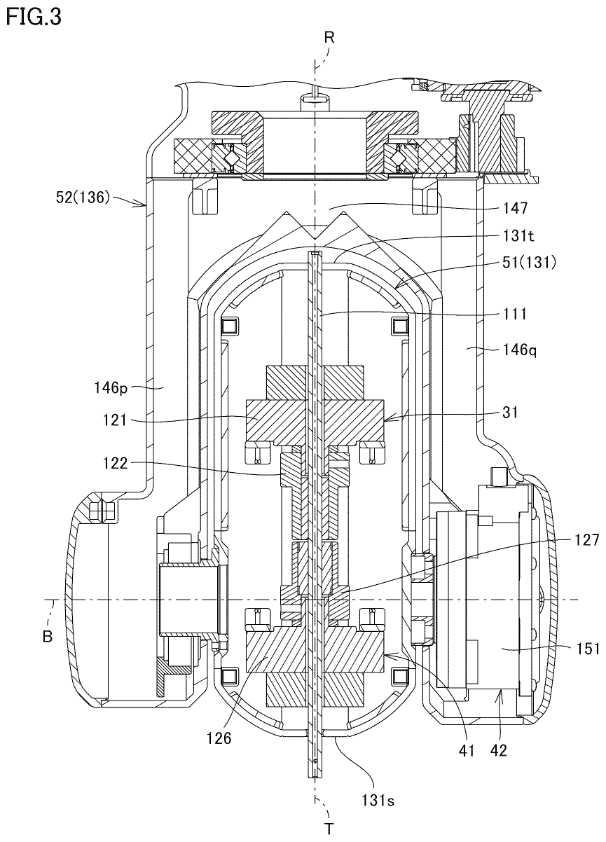

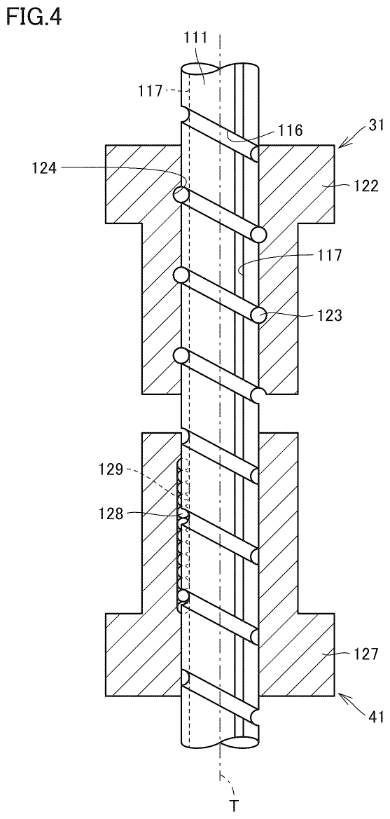

FIG. 3 is a cross-sectional view showing the robot in an area surrounded by chain double-dashed line III in FIG. 2. FIG. 4 is a cross-sectional view schematically showing the workings of a first rotation mechanism and a first slide mechanism.

Referring to FIGS. 1 to 4, robot 100 further has a first slide mechanism 31 and a first rotation mechanism 41. First slide mechanism 31 is connected to holding portion 21. First slide mechanism 31 is configured to slide holding portion 21 in the T-axis direction. First rotation mechanism 41 is connected to holding portion 21. First rotation mechanism 41 is configured to rotate holding portion 21 around the T axis.

First slide mechanism 31 and first rotation mechanism 41 are provided on the same straight line along the T axis. First slide mechanism 31, first rotation mechanism 41 and holding portion 21 are provided on the same straight line along the Taxis. First slide mechanism 31, first rotation mechanism 41, holding portion 21, and ultrasonic probe P are provided on the same straight line along the T axis. When robot 100 is viewed in the T-axis direction, first slide mechanism 31 and first rotation mechanism 41 overlap with each other. When robot 100 is viewed in the T-axis direction, first slide mechanism 31, first rotation mechanism 41 and holding portion 21 overlap with each other. When robot 100 is viewed in the T-axis direction, first slide mechanism 31, first rotation mechanism 41, holding portion 21, and ultrasonic probe P overlap with each other.

As shown in FIGS. 3 and 4, first slide mechanism 31 has a ball screw spline shaft 111, a ball screw nut 122 and a first hollow motor 121. Ball screw nut 122 and first hollow motor 121 are fixed in the T-axis direction.

Ball screw spline shaft 111 extends along the T axis. Holding portion 21 is connected to an end of ball screw spline shaft 111 in the T-axis direction. Ball screw spline shaft 111 and holding portion 21 are arranged side by side in the T-axis direction.

Ball screw spline shaft 111 is provided with a ball screw groove 116 and a plurality of ball spline grooves 117. Ball screw groove 116 has a groove shape that is recessed from an outer circumferential surface of ball screw spline shaft 111 and extends spirally around the T axis. Each of ball spline grooves 117 has a groove shape that is recessed from the outer circumferential surface of ball screw spline shaft 111 and extends linearly in the T-axis direction. The plurality of ball spline grooves 117 are spaced apart from each other in a circumferential direction around the T axis.

Ball screw nut 122 has a cylindrical shape around the T axis. Ball screw nut 122 is disposed on the outer circumference of ball screw spline shaft 111. Ball screw nut 122 is provided with a ball screw groove 124. Ball screw groove 124 has a groove shape that is recessed from an inner circumferential surface of ball screw nut 122 and extends spirally around the T axis. A plurality of balls 123 capable of circulating infinitely are interposed between ball screw groove 116 and ball screw groove 124.

First hollow motor 121 has a cylindrical shape around the T axis. First hollow motor 121 can selectively output, through an output shaft thereof, a rotation in a forward rotation direction around the T axis and a rotation in a reverse rotation direction around the T axis. First hollow motor 121 has ball screw spline shaft 111 inserted therethrough. The output shaft of first hollow motor 121 is connected to ball screw nut 122. The output shaft of first hollow motor 121 is connected to ball screw nut 122 without a motive power transmission mechanism such as a gear or a timing belt (directly-driven type).

In such a configuration, in response to the rotation from first hollow motor 121, ball screw nut 122 rotates in the forward rotation direction or the reverse rotation direction around the T axis. With the rotation of ball screw nut 122, ball screw spline shaft 111 moves back and forth along the T axis, which causes holding portion 21 to slide in the T-axis direction. As an example, a maximum slide length of holding portion 21 in the T-axis direction is 50 mm.

Holding portion 21 slides in the T-axis direction, which causes a change in distance between ultrasonic probe P and the affected area and a change in pressure of ultrasonic probe P on the affected area. By changing the pressure of ultrasonic probe P on the affected area, a depth of the affected area whose image is to be picked up can be adjusted and an obtained image can be sharpened.

First rotation mechanism 41 has ball screw spline shaft 111, a ball spline nut 127 and a second hollow motor 126.

First rotation mechanism 41 shares ball screw spline shaft 111 with first slide mechanism 31. Ball spline nut 127 and second hollow motor 126 are fixed in the T-axis direction. Ball spline nut 127 and second hollow motor 126 are provided between ball screw nut 122 and first hollow motor 121, and holding portion 21 in the T-axis direction. Ball screw nut 122 and ball spline nut 127 face each other in the T-axis direction.

Ball spline nut 127 has a cylindrical shape around the T axis. Ball spline nut 127 is disposed on the outer circumference of ball screw spline shaft 111. Ball spline nut 127 is provided with a plurality of ball spline grooves 129. Each of ball spline grooves 129 has a groove shape that is recessed from an inner circumferential surface of ball spline nut 127 and extends linearly in the T-axis direction. The plurality of ball spline grooves 129 are provided to correspond to the plurality of ball spline grooves 117. A plurality of balls 128 capable of circulating infinitely are interposed between ball spline groove 117 and ball spline groove 129.

Second hollow motor 126 has a cylindrical shape around the T axis. Second hollow motor 126 can selectively output, through an output shaft thereof, a rotation in a forward rotation direction around the T axis and a rotation in a reverse rotation direction around the T axis. Second hollow motor 126 has ball screw spline shaft 111 inserted therethrough. The output shaft of second hollow motor 126 is connected to ball spline nut 127. The output shaft of second hollow motor 126 is connected to ball spline nut 127 without a motive power transmission mechanism such as a gear or a timing belt (directly-driven type).

In such a configuration, in response to the rotation from second hollow motor 126, ball spline nut 127 rotates in the forward rotation direction or the reverse rotation direction around the T axis. Ball screw spline shaft 111 rotates in the forward rotation direction or the reverse rotation direction around the T axis integrally with ball spline nut 127, which causes holding portion 21 to rotate around the T axis. As an example, a rotation angle of holding portion 21 around the T axis is within a range of ±90° with respect to a reference posture in which a longitudinal direction of tip portion Pa of ultrasonic probe P matches the Y-axis direction (posture of holding portion 21 shown in FIGS. 1 and 2).

Holding portion 21 rotates around the T axis, which causes ultrasonic probe P to rotate (spin) (Rotating). For example, by rotating ultrasonic probe P, with tip portion Pa pressed against the affected area, a cross-sectional position of the affected area whose image is to be picked up can be changed.

Referring to FIGS. 1 to 3, robot 100 further has a first movable portion 51 and a second rotation mechanism 42. First slide mechanism 31 and first rotation mechanism 41 are provided in first movable portion 51. First movable portion 51 is connected to holding portion 21 through first slide mechanism 31 and first rotation mechanism 41.

First movable portion 51 has a first cover 131. First cover 131 has a cylindrical shape extending along the T-axis direction. First cover 131 has one end 131s and the other end 131t. One end 131s and the other end 131t correspond to both ends of first cover 131 extending along the T-axis direction.

First cover 131 is provided to cover first slide mechanism 31 and first rotation mechanism 41. Ball screw spline shaft 111 penetrates first cover 131 in the T-axis direction. Ball screw spline shaft 111 protrudes toward the outside of first cover 131 through one end 131s and the other end 131t. Ball screw nut 122, first hollow motor 121, ball spline nut 127, and second hollow motor 126 are housed inside first cover 131. First hollow motor 121 and second hollow motor 126 are attached to first cover 131. Outside first cover 131, holding portion 21 is connected to ball screw nut 122. Holding portion 21 is connected to ball screw nut 122 at a position where ball screw nut 122 protrudes toward the outside of first cover 131 through one end 131s.

First cover 131 may be provided with a lighting device (e.g., an LED) for lighting the affected area.

Second rotation mechanism 42 is connected to first movable portion 51. Second rotation mechanism 42 is configured to rotate holding portion 21 and first movable portion 51 around the B axis.

The B axis is an imaginary straight line and corresponds to a rotation central axis (sway central axis) of first movable portion 51. The B axis extends in the horizontal direction. The B axis does not intersect with holding portion 21 and ultrasonic probe P. The B axis intersects with first movable portion 51 (first cover 131) and a second movable portion 52 described below. The B axis is orthogonal to the T axis. Inside first cover 131, the B axis intersects with the T axis. A distance between the B axis and one end 131s in the T-axis direction is smaller than a distance between the B axis and the other end 131t in the T-axis direction.

Second rotation mechanism 42 has a first motor 151. First motor 151 is attached to a second cover 136 described below. First motor 151 is disposed to face first cover 131 in an axial direction of the B axis (hereinafter also referred to as “B-axis direction”). First motor 151 can selectively output, through an output shaft thereof, a rotation in a forward rotation direction around the B axis and a rotation in a reverse rotation direction around the B axis. The output shaft of first motor 151 is connected to first movable portion 51 (first cover 131). The output shaft of first motor 151 is connected to first movable portion 51 (first cover 131) without a motive power transmission mechanism such as a gear or a timing belt (directly-driven type).

In such a configuration, in response to the rotation from first motor 151, first movable portion 51 (first cover 131) rotates (sways) in the forward rotation direction or the reverse rotation direction around the B axis. Holding portion 21 moves in a circumferential direction around the B axis integrally with first movable portion 51. As an example, a rotation angle of first movable portion 51 around the B axis is within a range of ±90° with respect to a reference posture in which tip portion Pa of ultrasonic probe P faces directly downward (posture of first movable portion 51 shown in FIGS. 1 and 2).

First movable portion 51 rotates around the B axis, which causes a change in tilt of ultrasonic probe P (contact surface of tip portion Pa with respect to the affected area) (Rocking or Tilting). By changing the tilt of ultrasonic probe P, the range of the affected area whose image is to be picked up can be adjusted. In this case, driving of the axis configurations other than the B axis may be automatically controlled in order to maintain the position where tip portion Pa is pressed against the affected area or the pressure of tip portion Pa on the affected area.

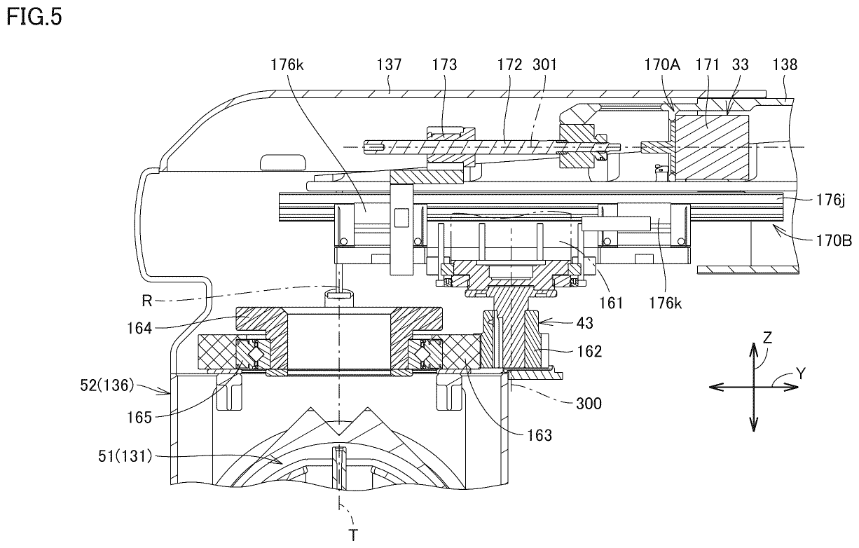

FIG. 5 is a cross-sectional view showing the robot in an area surrounded by chain double-dashed line V in FIG. 2. Referring to FIGS. 1 to 3 and FIG. 5, robot 100 further has second movable portion 52 and a third rotation mechanism 43. Second rotation mechanism 42 (first motor 151) is provided in second movable portion 52. Second movable portion 52 is connected to first movable portion 51 through second rotation mechanism 42 (first motor 151).

Second movable portion 52 has second cover 136. Second cover 136 has a pair of arm portions 146p and 146q and a base portion 147. Base portion 147 extends in the horizontal direction. The pair of arm portions 146p and 146q extend from both ends of base portion 147 in the Z-axis direction, respectively. Together with base portion 147, the pair of arm portions 146p and 146q form the U shape. The pair of arm portions 146p and 146q are spaced apart from each other and face each other in the B-axis direction.

First movable portion 51 (first cover 131) is provided between the pair of arm portions 146p and 146q and at a position where first movable portion 51 (first cover 131) faces base portion 147 in an axial direction of an R axis described below (hereinafter also referred to as “R-axis direction”). First movable portion 51 (first cover 131) is provided to cover second rotation mechanism 42 (first motor 151). Second rotation mechanism 42 (first motor 151) is attached to arm portion 146p. When the B axis is set to the reference posture in which tip portion Pa of ultrasonic probe P faces directly downward (posture of first movable portion 51 shown in FIGS. 1 and 2), base portion 147 faces the other end 131 t of first cover 131 in the R-axis direction, with a gap therebetween.

Third rotation mechanism 43 is connected to second movable portion 52 (second cover 136). Third rotation mechanism 43 is configured to rotate holding portion 21, first movable portion 51 and second movable portion 52 around the R axis.

The R axis is an imaginary straight line and corresponds to a rotation central axis of second movable portion 52. The R axis is orthogonal to the B axis. The R axis extends in the Z-axis direction. The R axis intersects with base portion 147 and extends between the pair of arm portions 146p and 146q. The R axis intersects with first movable portion 51. When the B axis is set to the reference posture in which tip portion Pa of ultrasonic probe P faces directly downward (posture of first movable portion 51 shown in FIGS. 1 and 2), the R axis is disposed on the same straight line as the T axis.

Third rotation mechanism 43 has a second motor 161, a first gear 162, a second gear 163, and a shaft 164.

Second motor 161 is attached to a slider 176k described below. Second motor 161 can selectively output, through an output shaft thereof, a rotation in a forward rotation direction around a rotation central axis 300 and a rotation in a reverse rotation direction around rotation central axis 300. Rotation central axis 300 extends in the R-axis direction (up-down direction). Rotation central axis 300 is provided at a position away from the R axis in the horizontal direction (Y-axis direction). First gear 162 is connected to the output shaft of second motor 161.

Shaft 164 extends axially along the R axis. Shaft 164 is attached to slider 176k described below. Second gear 163 is fitted on shaft 164 with a bearing 165 interposed therebetween. Second gear 163 is supported to be rotatable around the R axis. Second gear 163 is engaged with first gear 162. Second gear 163 is connected to second movable portion 52 (second cover 136). Second gear 163 is fastened to base portion 147 using a bolt or the like.

In such a configuration, in response to the rotation from second motor 161, first gear 162 rotates in the forward rotation direction or the reverse rotation direction around rotation central axis 300. The rotation of first gear 162 is transmitted to second gear 163, which causes second movable portion 52 (second cover 136) to rotate around the R axis integrally with second gear 163. As an example, a rotation angle of second movable portion 52 around the R axis is within a range of ±90° with respect to a reference posture in which the pair of arm portions 146p and 146q face each other in the Y-axis direction (posture of second movable portion 52 shown in FIGS. 1 and 2).

Second movable portion 52 rotates around the R axis, whereby a posture of ultrasonic probe P with respect to the affected area can be changed. Particularly when the B axis is set to the reference posture in which tip portion Pa of ultrasonic probe P faces directly downward (posture of first movable portion 51 shown in FIGS. 1 and 2), the same effect as that when holding portion 21 is rotated around the T axis by first rotation mechanism 41 is obtained.

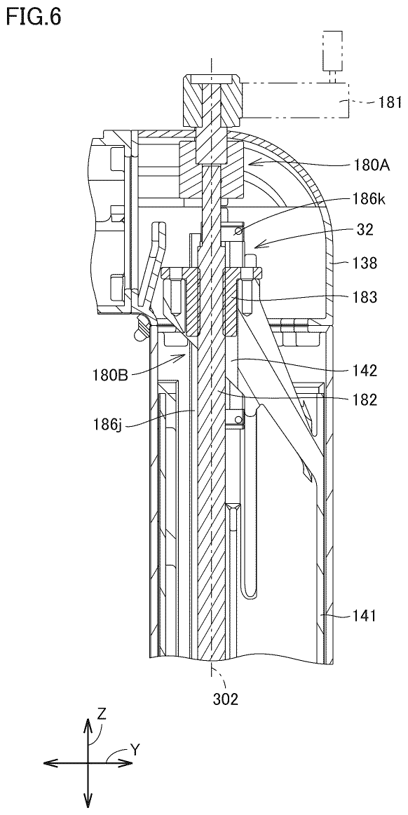

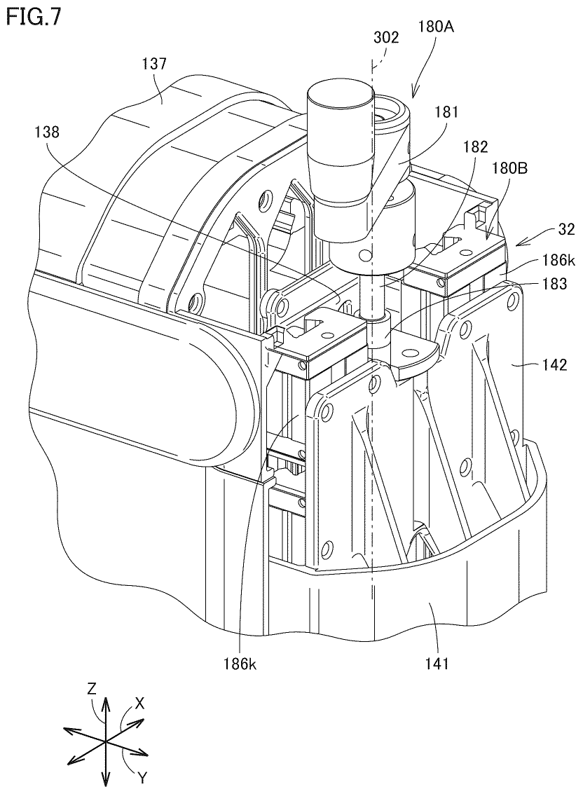

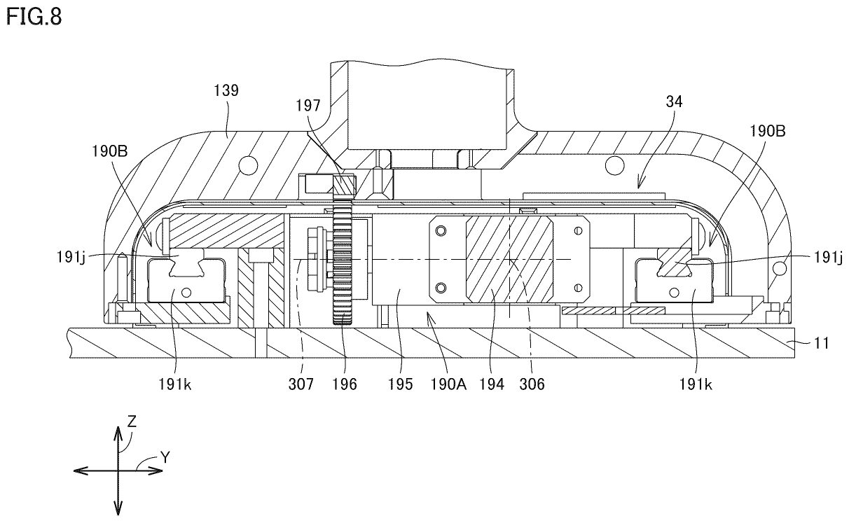

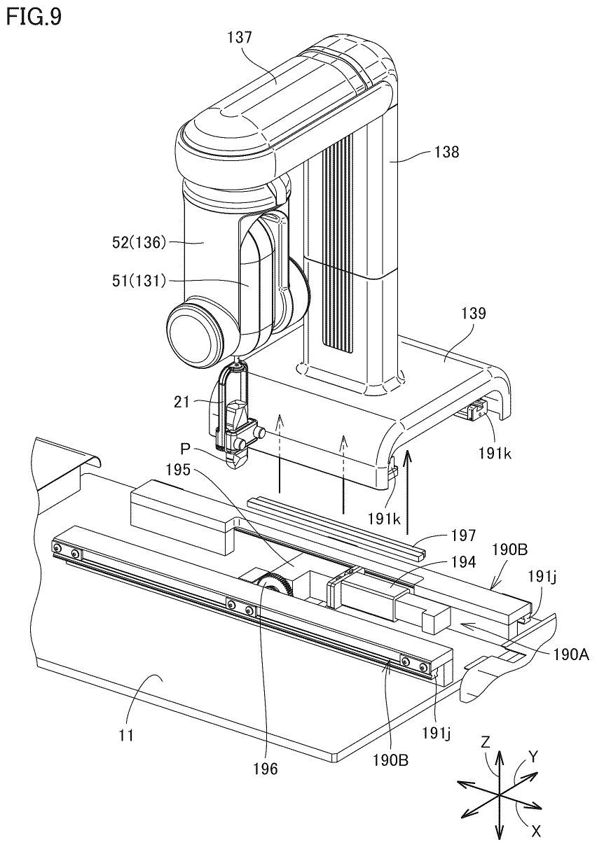

FIG. 6 is a cross-sectional view showing the robot in an area surrounded by chain double-dashed line VI in FIG. 2. FIG. 7 is a perspective view showing an internal structure of the robot in FIG. 6. FIG. 8 is a cross-sectional view of the robot in an area surrounded by chain double-dashed line VIII in FIG. 2. FIG. 9 is an exploded view of the robot in FIG. 1.

Referring to FIGS. 1 to 2 and FIGS. 5 to 9, robot 100 further has a second slide mechanism 32, a third slide mechanism 33 and a fourth slide mechanism 34.

Second slide mechanism 32 is configured to slide holding portion 21 in the Z-axis direction (up-down direction). Third slide mechanism 33 is configured to slide holding portion 21 in the Y-axis direction (width direction of the arm placed on pedestal 11). Fourth slide mechanism 34 is configured to slide holding portion 21 in the X-axis direction (longitudinal direction of the arm placed on pedestal 11). Second slide mechanism 32 is of manual type. Third slide mechanism 33 and fourth slide mechanism 34 are of motor-driven type.

First, a structure of third slide mechanism 33 will be described. As shown in FIG. 5, robot 100 further has a third cover 137. Third cover 137 is made of a cylindrical body that is open downward and extends in the Y-axis direction. Second movable portion 52 (second cover 136) extends from third cover 137 toward the Z-axis direction (downward). Third cover 137 is provided to cover third slide mechanism 33.

Third slide mechanism 33 has a feed mechanism 170A and a guide mechanism 170B. Feed mechanism 170A moves second movable portion 52 (second cover 136) in the Y-axis direction through motor driving. Guide mechanism 170B guides second movable portion 52 (second cover 136) along the Y-axis direction.

Feed mechanism 170A has a third motor 171, a ball screw shaft 172 and a ball screw nut 173.

Third motor 171 is attached to a fourth cover 138 described below. Third motor 171 can selectively output, through an output shaft thereof, a rotation in a forward rotation direction around a rotation central axis 301 and a rotation in a reverse rotation direction around rotation central axis 301. Rotation central axis 301 extends in the Y-axis direction. Ball screw shaft 172 extends along rotation central axis 301. Ball screw shaft 172 is connected to the output shaft of third motor 171. Ball screw nut 173 is engaged with ball screw shaft 172 with a plurality of balls interposed therebetween. Together with ball screw shaft 172, ball screw nut 173 forms a ball screw.

Guide mechanism 170B has a rail 176j and slider 176k. Rail 176j is attached to third cover 137. Rail 176j extends in the Y-axis direction. Slider 176k is engaged with rail 176j with a plurality of balls interposed therebetween. Rail 176j and slider 176k are guided each other, whereby rail 176j and slider 176k can move relatively in the Y-axis direction. Rail 176j and slider 176k form a linear guide, which is a linear motion guide mechanism. Slider 176k is connected to ball screw nut 173.

Second motor 161 and shaft 164 are connected to slider 176k. Second movable portion 52 (second cover 136) is supported by slider 176k through shaft 164 and second gear 163. Second movable portion 52 (second cover 136) is hung from slider 176k through shaft 164 and second gear 163.

In such a configuration, in response to the rotation from third motor 171, ball screw shaft 172 rotates in the forward rotation direction or the reverse rotation direction around rotation central axis 301. With the rotation of ball screw shaft 172, ball screw nut 173 moves along rotation central axis 301, which causes slider 176k to move in the Y-axis direction while being guided by rail 176j. Holding portion 21 slides in the Y-axis direction integrally with second movable portion 52 (second cover 136) supported by slider 176k. As an example, a maximum slide length of holding portion 21 in the Y-axis direction by third slide mechanism 33 is 50 mm.

Next, a structure of second slide mechanism 32 will be described. As shown in FIGS. 6 and 7, robot 100 further has fourth cover 138. Fourth cover 138 is made of a cylindrical body extending in the Z-axis direction. Third cover 137 extends from an upper end of fourth cover 138 toward the Y-axis direction. Fourth cover 138 is provided to cover second slide mechanism 32.

Second slide mechanism 32 has a feed mechanism 180A and a guide mechanism 180B. Feed mechanism 180A manually moves fourth cover 138 in the Z-axis direction. Guide mechanism 180B guides fourth cover 138 along the Z-axis direction.

Feed mechanism 180A has a handle 181, a ball screw shaft 182 and a ball screw nut 183.

Ball screw shaft 182 extends along a rotation central axis 302. Rotation central axis 302 extends in the Z-axis direction. Handle 181 is connected to ball screw shaft 182. An operator can selectively input, through handle 181, a rotation in a forward rotation direction around rotation central axis 302 and a rotation in a reverse rotation direction around rotation central axis 302 to ball screw shaft 182. Ball screw shaft 182 and handle 181 are attached to fourth cover 138. Ball screw nut 183 is engaged with ball screw shaft 182 with a plurality of balls interposed therebetween. Together with ball screw shaft 182, ball screw nut 183 forms a ball screw.

Guide mechanism 180B has a rail 186j and a slider 186k. Rail 186j is attached to fourth cover 138. Rail 186j extends in the Z-axis direction. Slider 186k is engaged with rail 186j with a plurality of balls interposed therebetween. Rail 186j and slider 186k are guided each other, whereby rail 186j and slider 186k can move relatively in the Z-axis direction. Rail 186j and slider 186k form a linear guide, which is a linear motion guide mechanism.

Ball screw nut 183 and slider 186k are connected to a column 141. Column 141 is supported by a fifth cover 139 described below. Column 141 has a column shape rising from fifth cover 139. Column 141 has a plate portion 142. Plate portion 142 is disposed in fourth cover 138. Plate portion 142 is made of a plate member whose thickness direction corresponds to the Y-axis direction. Ball screw nut 183 and slider 186k are connected to plate portion 142.

In such a configuration, handle 181 is rotated by the operator, which causes ball screw shaft 182 to rotate in the forward rotation direction or the reverse rotation direction around rotation central axis 302. Ball screw shaft 182 rotates with respect to ball screw nut 173, thereby moving back and forth along rotation central axis 302. Fourth cover 138 slides in the Z-axis direction integrally with ball screw shaft 182, while rail 186j is guided by slider 186k. As an example, a maximum slide length of holding portion 21 in the Z-axis direction by second slide mechanism 32 is 200 mm.

Next, a structure of fourth slide mechanism 34 will be described. As shown in FIGS. 8 and 9, robot 100 further has fifth cover 139. Fifth cover 139 is made of a cylindrical body that is open downward and extends in the X-axis direction. Fifth cover 139 is provided on pedestal 11. Column 141 is connected to an upper end of fifth cover 139.

Fourth slide mechanism 34 has a feed mechanism 190A and a guide mechanism 190B. Feed mechanism 190A moves fifth cover 139 in the X-axis direction through motor driving. Guide mechanism 190B guides fifth cover 139 along the X-axis direction.

Feed mechanism 190A has a fourth motor 194, a reducer 195, a pinion 196, and a rack 197.

Fourth motor 194 is attached to pedestal 11. Fourth motor 194 can selectively output, through an output shaft thereof, a rotation in a forward rotation direction around a rotation central axis 306 and a rotation in a reverse rotation direction around rotation central axis 306. Rotation central axis 306 extends in the X-axis direction. Reducer 195 is provided on a motive power transmission path from fourth motor 194 to pinion 196. While reducing the speed of rotation from fourth motor 194, reducer 195 converts the rotation around rotation central axis 306 by 90° into rotation around a rotation central axis 307 and transmits the rotation around rotation central axis 307 to pinion 196. Pinion 196 can rotate around rotation central axis 307. Rotation central axis 307 extends in the Y-axis direction.

Rack 197 is attached to fifth cover 139. Rack 197 extends in the X-axis direction. Rack 197 is engaged with pinion 196.

Guide mechanism 190B has a rail 191j and a slider 191k. Rail 191j is attached to pedestal 11. Rail 191j extends in the X-axis direction. Slider 191k is engaged with rail 191j with a plurality of balls interposed therebetween. Rail 191j and slider 191k are guided each other, whereby rail 191j and slider 191k can move relatively in the X-axis direction. Rail 191j and slider 191k form a linear guide, which is a linear motion guide mechanism.

In such a configuration, in response to the rotation from fourth motor 194, pinion 196 rotates in the forward rotation direction or the reverse rotation direction around rotation central axis 307. Rack 197 is engaged with pinion 196 that rotates around rotation central axis 307, whereby the driving force in the X-axis direction is provided to fifth cover 139. Fifth cover 139 slides in the X-axis direction, while being guided by the engagement between slider 176k and rail 176j. As an example, a maximum slide length of holding portion 21 in the X-axis direction by fourth slide mechanism 34 is 300 mm.

The maximum slide length of holding portion 21 in the X-axis direction by fourth slide mechanism 34 is greater than the maximum slide length of holding portion 21 in the Z-axis direction by second slide mechanism 32, and is greater than the maximum slide length of holding portion 21 in the Y-axis direction by third slide mechanism 33. The maximum slide length of holding portion 21 in the Z-axis direction by second slide mechanism 32 is greater than the maximum slide length of holding portion 21 in the Y-axis direction by third slide mechanism 33.

Holding portion 21 slides in the Y-axis direction and in the X-axis direction by second slide mechanism 32 and fourth slide mechanism 34, respectively, which causes ultrasonic probe P to move in a horizontal plane (Sliding). Thus, ultrasonic probe P can approach the position of the affected area to be treated. In addition, holding portion 21 slides in the Z-axis direction by third slide mechanism 33, which causes ultrasonic probe P to move in the Z-axis direction. Thus, ultrasonic probe P can be roughly positioned in advance with respect to affected areas having various sizes, for example.

Referring to FIG. 1, robot 100 further has a laser irradiation device 16. Laser irradiation device 16 is attached to third cover 137. Laser irradiation device 16 emits a laser (line laser) toward pedestal 11. The line laser extends in the shape of a line in the X-axis direction. According to such a configuration, the doctor can use the line laser applied to the affected area as a guide when ultrasonic probe P is scanned.

The configuration of robot 100 according to the embodiment of the present invention described above will be summarized. Robot 100 according to the present embodiment is a robot for scanning ultrasonic probe P. Robot 100 includes: holding portion 21 that can hold ultrasonic probe P; first slide mechanism 31 that is connected to holding portion 21 and slides holding portion 21 in the axial direction of the T axis as the first axis intersecting with ultrasonic probe P; and first rotation mechanism 41 that is connected to holding portion 21 and rotates holding portion 21 around the T axis.

According to such a configuration, holding portion 21 is slid in the T-axis direction by first slide mechanism 31, which causes a change in distance between ultrasonic probe P and the affected area and a change in pressure of ultrasonic probe P on the affected area. In addition, holding portion 21 is rotated around the T axis by first rotation mechanism 41, whereby ultrasonic probe P can be rotated, with ultrasonic probe P pressed against the affected area. This makes it possible to change a range of image pick-up by ultrasonic probe P as intended and to easily sharpen an obtained image, and the image pick-up work using ultrasonic probe P can be performed smoothly.

First slide mechanism 31 includes: ball screw spline shaft 111 that is connected to holding portion 21; ball screw nut 122 that is engaged with ball screw spline shaft 111; and first hollow motor 121 that has ball screw spline shaft 111 inserted therethrough and is connected to ball screw nut 122. First rotation mechanism 41 includes: ball screw spline shaft 111 that is shared with first slide mechanism 31; ball spline nut 127 that is engaged with ball screw spline shaft 111; and second hollow motor 126 that has ball screw spline shaft 111 inserted therethrough and is connected to ball spline nut 127.

According to such a configuration, first slide mechanism 31 for sliding holding portion 21 in the T-axis direction and first rotation mechanism 41 for rotating holding portion 21 around the T axis can be configured in a compact manner along the T axis. Robot 100 further includes: first movable portion 51 where first slide mechanism 31 and first rotation mechanism 41 are provided; second rotation mechanism 42 that is connected to first movable portion 51 and rotates holding portion 21 and first movable portion 51 around the B axis as the second axis orthogonal to the T axis; second movable portion 52 where second rotation mechanism 42 is provided; and third rotation mechanism 43 that is connected to second movable portion 52 and rotates holding portion 21, first movable portion 51 and second movable portion 52 around the R axis as the third axis orthogonal to the B axis.

According to such a configuration, holding portion 21 and first movable portion 51 are rotated around the B axis by second rotation mechanism 42, and holding portion 21, first movable portion 51 and second movable portion 52 are rotated around the R axis by third rotation mechanism 43, which causes a change in posture of ultrasonic probe P. This makes it possible to adjust the range of the affected area whose image is to be picked up, and the image pick-up work using ultrasonic probe P can be performed further smoothly.

Robot 100 further includes: second slide mechanism 32 that slides holding portion 21 in the Z-axis direction as the first direction parallel to the up-down direction; third slide mechanism 33 that slides holding portion 21 in the Y-axis direction as the second direction orthogonal to the Z-axis direction; and fourth slide mechanism 34 that slides holding portion 21 in the X-axis direction as the third direction orthogonal to each of the Z-axis direction and the Y-axis direction.

According to such a configuration, holding portion 21 is slid in the Z-axis direction, in the Y-axis direction and in the X-axis direction by second slide mechanism 32, third slide mechanism 33 and fourth slide mechanism 34, respectively, which causes a change in three-dimensional position of ultrasonic probe P. This makes it possible to adjust the range of the affected area whose image is to be picked up, and the image pick-up work using ultrasonic probe P can be performed further smoothly.

Second slide mechanism 32 is of manual type. Third slide mechanism 33 and fourth slide mechanism 34 are of motor-driven type.

According to such a configuration, by using second slide mechanism 32 of manual type and third slide mechanism 33 and fourth slide mechanism 34 of motor-driven type depending on the situation, the image pick-up work using ultrasonic probe P can be performed further smoothly. For example, second slide mechanism 32 can be used to position ultrasonic probe P with respect to the affected area, and third slide mechanism 33 and fourth slide mechanism 34 can be used to move ultrasonic probe P at the time of searching for the affected area.

Although the embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

1. A robot for scanning using an ultrasonic probe, the robot comprising:
a holding portion configured to hold the ultrasonic probe;
a first slide mechanism connected to the holding portion and configured to slide the holding portion in an axial direction of a first axis intersecting with the ultrasonic probe; and
a first rotation mechanism connected to the holding portion and configured to rotate the holding portion around the first axis.
wherein the first slide mechanism and the first rotation mechanism are arranged coaxially along the first axis and share a single ball screw spline shaft, the first slide mechanism being configured to generate linear motion of the holding portion along the first axis, and the first rotation mechanism being configured to generate rotational motion of the holding portion about the first axis independently of the linear motion.

2. The robot according to claim 1, wherein
the first slide mechanism includes:
a ball screw spline shaft that is connected to the holding portion;
a ball screw nut that is engaged with the ball screw spline shaft; and
a first hollow motor that has the ball screw spline shaft inserted therethrough and is connected to the ball screw nut, and
the first rotation mechanism includes:
the ball screw spline shaft that is shared with the first slide mechanism;
a ball spline nut that is engaged with the ball screw spline shaft; and
a second hollow motor that has the ball screw spline shaft inserted therethrough and is connected to the ball spline nut.

3. The robot according to claim 1, further comprising:
a first movable portion where the first slide mechanism and the first rotation mechanism are provided;
a second rotation mechanism that is connected to the first movable portion and rotates the holding portion and the first movable portion around a second axis orthogonal to the first axis;
a second movable portion where the second rotation mechanism is provided; and
a third rotation mechanism that is connected to the second movable portion and rotates the holding portion, the first movable portion and the second movable portion around a third axis orthogonal to the second axis.

4. The robot according to claim 1, further comprising:
a second slide mechanism that slides the holding portion in a first direction parallel to an up-down direction;
a third slide mechanism that slides the holding portion in a second direction orthogonal to the first direction; and
a fourth slide mechanism that slides the holding portion in a third direction orthogonal to each of the first direction ad the second direction.

5. The robot according to claim 4, wherein
the second slide mechanism is of manually operated, and
the third slide mechanism and the fourth slide mechanism are driven by motors.
